(19) United States
(12) Patent Application Publication
(10) Pub. No.: US 2009/0225153 A1
(43) Pub. Date: Sep. 10, 2009

(54) Apparatus For Synthesizing Information, Apparatus For Controlling Information, And Computer Program Product

(76) Inventors: Naohisa Shibuya, Kanagawa (JP); Takuya Kawamura, Kanagawa (JP); Shingo Tanaka, Kanagawa (JP); Nobuhiko Sugasawa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/791,492

(22) PCT Filed: Mar. 16, 2007
(86) PCT No.: PCT/JP2007/056124

§ 371 Date: May 24, 2007

(30) Foreign Application Priority Data
Sep. 27, 2006 (JP) 2006-263550

(51) Int. Cl. H04N 7/15; H04L 12/16

(52) U.S. Cl. 348/14.13; 370/260; 348/E07.083

(57) ABSTRACT

A communication controller receives first ID and second ID indicative of two information synthesizers bilaterally connected to each other from each of the information synthesizers; stores therein the first ID and the second ID associated with each other; and assigns a one of the terminal devices to the first information synthesizer and other of the terminal devices to the second information synthesizer, when both of the first information and the second information from the first information synthesizer match those from the second information synthesizer.

### TECHNICAL FIELD

The present invention relates to an apparatus for synthesizing information received, an apparatus for controlling information received, and a computer program product.

### BACKGROUND ART

A multipoint teleconference system has been used to connect a plurality of teleconference terminals to one another via a network and exchange image data and sound data among the conference terminals.

Such a multipoint teleconference system often includes a media synthesizer. Resources of the media synthesizer used in the multipoint teleconference system are limited. An example of the media synthesizer is an image synthesizer that synthesizes the image data received from the conference terminal.

The image synthesizer receives the image data from the conference terminals, decompresses the received image data, synthesizes the decompressed data, compresses the synthesized data, and sends the compressed data. The image synthesizer uses software or hardware to perform the processes. However, the number of processable images is limited, and the number of the conference terminals that can be connected to the image synthesizer at the same time is also limited.

As described above, the image synthesizer can be connected to only limited number of conference terminals. However, there is a need to connect more conference terminals to a single image synthesizer.

JP-A H8-88842 (KOKAI) (hereinafter, “a first document”) discloses a technology that can realize a large conference by cascadingly connecting the image synthesizers (referred to as MCU's in the first document) to one another.

“Operating Instructions for SONY's Video Communication System PCS-111P, Chap. 8. “Multipoint Videoconference”; Sony Corporation; 2003” (hereinafter, “a second document”) describes a videoconference system that enables a multipoint videoconference at as many as ten locations by connecting a plurality of the image synthesizers to each other, each of which is connected to the limited number of the conference terminals.

According to the technologies described in the first and second documents, mapping between the media synthesizer and the conference terminals and mapping of the cascade connection between the media synthesizers is fixed in the multipoint teleconference system. In other words, a user needs to manually assign the conference terminals to be connected to each media synthesizer and the cascadingly connect between the media synthesizers. To realize the multipoint teleconference by taking advantage of the resources of the media synthesizer, a complicated setting work is required.

### DISCLOSURE OF INVENTION

According to one aspect of the present invention, a communication controller that controls communications of devices via a multiplex communication network, the devices including at least two information synthesizers bilaterally connected with an exclusive line and at least two terminal devices that send information to be synthesized by the information synthesizers, the communication controller includes: a receiving unit that receives first ID and second ID from the information synthesizers, the first ID being ID of an information synthesizer bilaterally connected to one of the information synthesizers and second ID being ID of the one of the information synthesizers; a storage unit that stores the first ID received and the second ID received associated with each other; and an assigning unit that assigns a one of the terminal devices to the first information synthesizer and the other of the terminal devices to the second information synthesizer, when both of the first ID and the second ID received from the first information synthesizer match both of the first ID and the second ID received from the second information synthesizer.

According to another aspect of the present invention, an information synthesizer includes: a first communicating unit that receives ID of other information synthesizer, sends ID of the information synthesizer to the other information synthesizer, and receives first information to be synthesized via an exclusive line that bilaterally connects the information synthesizer to the other information synthesizer; a second communicating unit that sends the ID of the other information synthesizer to a communication controller along with the ID of the information synthesizer, receives the ID of a first terminal device from the communication controller, and receives second information to be synthesized from the first terminal device via a multiplex communication network for multiplex communication with the first terminal device, the communication controller, and the other information synthesizer; and a synthesizing unit that synthesizes the first information and the second information to generate synthesized information.

According to still another aspect of the present invention, a computer program product having a computer readable medium including programmed instructions for controlling communications of devices via a multiplex communication network, the devices including at least two information synthesizers bilaterally connected with an exclusive line and at least two terminal devices that send information to be synthesized by the information synthesizers, wherein the instructions, when executed by a computer, cause the computer to perform: receiving first ID and second ID from the information synthesizers, the first ID being ID of an information synthesizer bilaterally connected to one of the information synthesizers and second ID being ID of the one of the information synthesizers; storing the first ID received and the second ID received associated with each other; and assigning one of the terminal devices to the first information synthesizer and the other of the terminal devices to the second information synthesizer, when both of the first ID and the second ID received from the first information synthesizer match both of the first ID and the second ID received from the second information synthesizer.

According to still another aspect of the present invention, a computer program product having a computer readable medium including programmed instructions for synthesizing information to be synthesized and generating synthesized information, wherein the instructions, when executed by a computer, cause the computer to perform: receiving ID of an information synthesizer via an exclusive line; sending ID of the computer to the information synthesizer via the exclusive line; sending the ID of the information synthesizer to a communication controller via a multiplex communication network along with the ID of the computer; receiving ID of a terminal device from the communication controller via the multiplex communication network; receiving first information from the information synthesizer via the exclusive line; receiving second information to be synthesized from the terminal device via the multiplex communication network; sending the second information to the information synthesizer via the exclusive line; and synthesizing the first information and the second information to generate synthesized information.

### BRIEF DESCRIPTION OF DRAWINGS

FIG. 1 is a schematic view of a multipoint teleconference system according to an embodiment of the present invention;

FIG. 2 is a block diagram of an image synthesizer shown in FIG. 1;

FIG. 3 is a block diagram of a conference controller shown in FIG. 1;

FIG. 4 is an example of a management table in a resource storage unit shown in FIG. 3;

FIG. 5 is a flowchart of a registration process performed by the image synthesizer;

FIG. 6 is a sequence diagram of message transmission in the registration process;

FIG. 7 is a flowchart of a process of registering information to the resource storage unit;

FIG. 8 is an example of the management table after a registering unit shown in FIG. 3 registers an entry of a first image synthesizer;

FIG. 9 is an example of the management table after the registering unit registers an entry of a second image synthesizer;

FIG. 10 is a flowchart of a process of the conference controller starting and terminating a conference;

FIG. 11 is a sequence diagram of the message transmission when the conference starts;

FIG. 12 is an example of the management table before the conference starts;

FIG. 13 is a flowchart of the image synthesizer synthesizing image data when it is clustered with another image synthesizer;

FIGS. 14A to 14D are examples of a screen layout displayed on a conference terminal during the conference;

FIG. 15 is an example of a data configuration of layout information in a controlling unit of the image synthesizer;

FIG. 16 is an example of the data configuration of the layout information when the image synthesizer is clustered;

FIG. 17 is a sequence diagram of the message transmission when the conference is terminated;

FIG. 18 is a block diagram of hardware in the image synthesizer; and

FIG. 19 is a block diagram of hardware in the conference controller.

### BEST MODE(S) FOR CARRYING OUT THE INVENTION

Exemplary embodiments of the present invention are explained below in detail referring to the accompanying drawings. The explanation is given assuming that an information synthesizer according to the present embodiment is applied to an image synthesizer and an information controller according to the present embodiment is applied to a conference controller. The present invention is not limited to the embodiments explained below. The information synthesizer and the information controller can be applied to other devices.

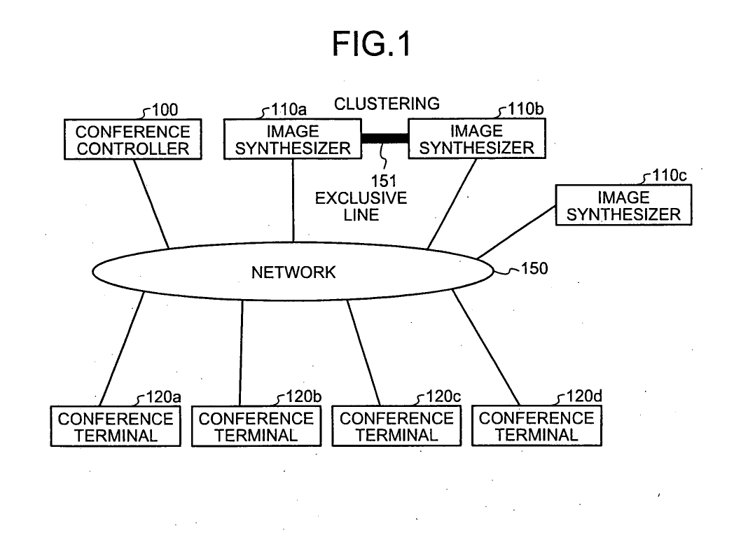

As shown in FIG. 1, a multipoint teleconference system according to an embodiment of the present invention includes conference terminals 120a to 120d, image synthesizers 110a, 110b, and 110c, a conference controller 100, and a network 150 that connects them to one another. The network is a multiplex communication network.

The conference terminals 120a to 120d are used to participate in a teleconference. Each of the conference terminals 120a to 120d sends image data of a participant to an image synthesizer, receives image data of other participants from the image synthesizer, and displays the image data.

The image synthesizers 110a, 110b, and 110c receive the image data from the conference terminals 120a to 120d, synthesize image data of each conference terminal from the received image data, and send the synthesized data to the conference terminals 120a to 120d.

The conference controller 100 controls connections between the conference terminals 120a to 120d and the image synthesizers 110a, 110b, and 110c when the conference terminals 120a to 120d hold the conference.

Although the four conference terminals 120a to 120d are connected to the network in FIG. 1, the number of the conference terminals used in the teleconference is not limited to four.

The image synthesizers 110a and 110b are connected one-to-one via an exclusive line 151 so that they can communicate with each other via the exclusive line 151 for a so-called bilateral connection (hereinafter, “clustering”). The image synthesizer 110c is included in the multipoint teleconference system as an independent device that is not clustered with other image synthesizers.

To connect the conference controller 100, the image synthesizers 110a, 110b, and 110c, and the conference terminals 120a to 120d, a best-effort packet-switching network such as the Internet is used in the embodiment. The network that connects them is not limited to the packet-switching network, and any type of network can be used regardless of a wireless line or a wired line.

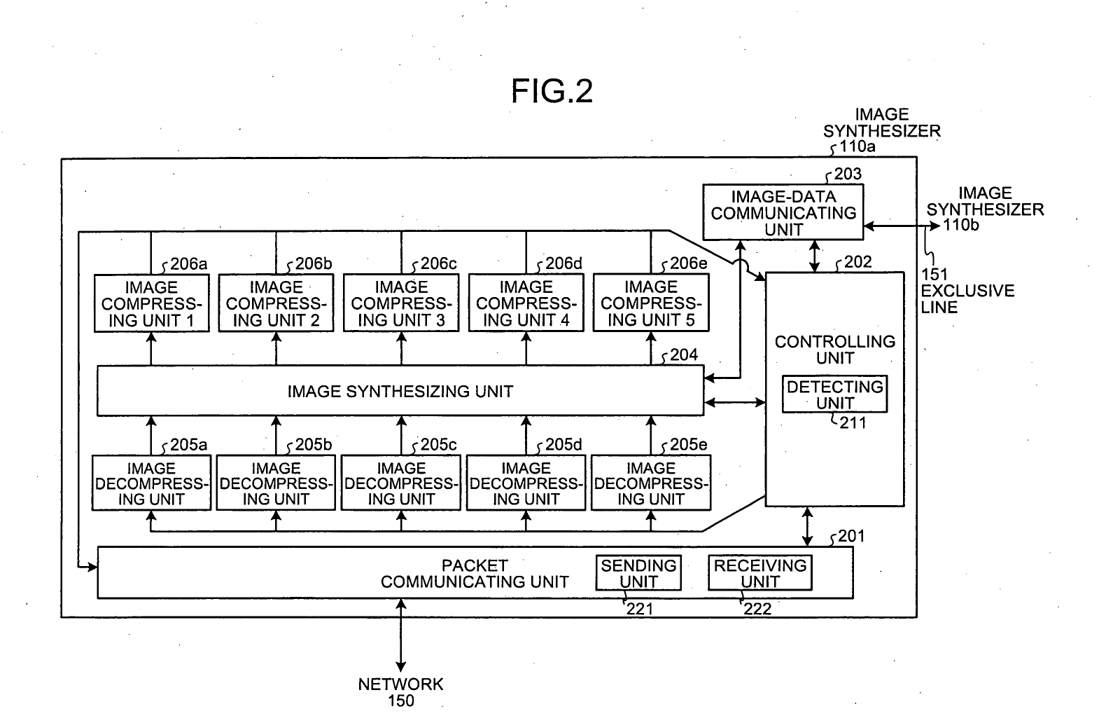

As shown in FIG. 2, the image synthesizer 110a includes a packet communicating unit 201, a controlling unit 202, an image-data communicating unit 203, an image synthesizing unit 204, image decompressing units 205a to 205e, and image compressing units 206a to 206e. The image synthesizer 110b includes the same units, and the explanation thereof is omitted.

The image synthesizer 110a basically follows an instruction from the conference controller 100. It receives image data from conference terminals that are used in a teleconference specified by the conference controller 100, synthesizes the received image data, and sends the synthesized data to other conference terminals.

The image decompressing units 205a to 205e perform decompression, and the image compressing units 206a to 206e perform compression. By using them, the image synthesizer 110a is connected to five conference terminals and performs the decompression and the compression of the image data with respect to each conference terminal. The number of the image decompressing units and the image compressing units depends on the number of the maximum conference terminals required by the image synthesizer 110a, and it is not limited to five.

The packet communicating unit 201 includes a sending unit 221 and a receiving unit 222. It sends and receives various types of data, session controlling information, or other protocol information with the conference terminals 120a to 120d via the network 150. The types of the data will be explained with the sending unit 221 and the receiving unit 222.

The packet communicating unit 201 uses communication protocols such as a session initiation protocol (SIP) (RFC3261: a signaling protocol to control initiation and termination of a session) standardized by Internet Engineering Task Force (IETF), a real-time transport protocol/RTP control protocol (RTP/RTCP) (RFC3550: a protocol to send and receive real-time data such as image and sound data or to monitor and control the real-time data), a transmission control protocol/user datagram protocol (TCP/UDP) that is a lower protocol to transfer protocol information, an internet protocol (IP), and Ethernet (registered trademark).

The protocols used by the packet communicating unit 201 comply with specifications of a conference system that uses image data, and other protocols can be used.

The sending unit 221 sends registration information for registering the image synthesizer 110a to the conference controller 100, control data for connecting and disconnecting conference terminals, and image data synthesized from the image data sent from other conference terminals.

The registration information includes an identifier of the image synthesizer 110a (for example, a media access control (MAC) address) and an IP address. If the image synthesizer 110a is clustered with another image synthesizer, the registration information includes an identifier of the other image synthesizer. The registration process will be explained later. The registration information can include the maximum number of the resources. The maximum number of the resources is the number of the conference terminals that the image synthesizer 110a can operate, and it is five in the case of the image synthesizer 110a.

The receiving unit 222 receives a request for starting the conference, the control data for connecting and disconnecting conference terminals from the conference controller 100, and image data sent from the conference terminals 120a to 120d.

The image decompressing units 205a to 205e decompress the image data received by the receiving unit 222. A single image decompressing unit decompresses image data sent from a corresponding conference terminal. If the received image data is coded differently (for example, decompression coding method, resolution, frame rate, bit rate) with respect to each conference terminal, the image decompressing units 205a to 205e decompress each image data in an appropriate method.

The controlling unit 202 includes a detecting unit 211, and controls the entire image synthesizer 110a. The controlling unit 202 instructs the image-data communicating unit 203 to perform clustering and analyzes the protocol of the packet received by the packet communicating unit 201. Moreover, the controlling unit 202 generates the registration information for registering the image synthesizer 110a to the conference controller 100, and outputs it to the packet communicating unit 201. The registration information is then sent by the sending unit 221.

The controlling unit 202 issues an instruction of session control such as the start and the termination of the conference with other conference terminals based on the information from the conference controller 100.

The controlling unit 202 controls to output the image data that the packet communication unit 201 received from other conference terminals to each image decompressing unit. The controlling unit 202 packetizes the compressed synthesized image data based on the protocol appropriate to the conference terminal to which it is sent, and outputs the packet to the packet communication unit 201. The controlling unit 202 controls an image-synthesis arrangement pattern in the image synthesizing unit 204. The controlling unit 202 instructs the image compressing units 206a to 206e and the image decompressing units 205a to 205e to set or change various parameters, methods, and the like.

The detecting unit 211 controls the image-data communicating unit 203 to detect an image synthesizer clustered via the exclusive line 151.

The image-data communicating unit 203 exchanges the image data with the image synthesizer 110b clustered via an exclusive signal line other than the network 150. The image-data communicating unit 203 sends the image data decompressed by the image decompressing units 205a to 205e, and receives the image data decompressed by the image synthesizer 110b.

The image-data communicating unit 203 detects the clustered image synthesizer and exchanges identifiers with the clustered image synthesizer 110b via the exclusive signal line. The identifier is a piece of unique information that identifies the image synthesizer, and a MAC address is used herein as the identifier.

A signal line for one-to-one connection is used as a clustering interface that clusters the image synthesizers, which is connected with a cable and connectors when the image synthesizers are installed. According to the embodiment, the image synthesizers are connected one-to-one. Therefore, for example, by the image-data communicating unit 203 monitoring voltage of the signal line for detection of the clustering, it is detected that the image synthesizers are clustered. Moreover, because the image synthesizers are connected one-to-one with the exclusive line 151, it is guaranteed that the image-data communicating unit 203 exchanges information with an appropriate device without authorization or coding/decoding.

Apart from the embodiment, a wireless interface such as a wireless local area network (wireless LAN) or Bluetooth (registered trademark) can be used as the clustering interface. To cluster the image synthesizers using the wireless interface, a certain device is required to make sure that the connection is made with the desired image synthesizer or that appropriate information is exchanged with the appropriate image synthesizer.

Returning to the explanation of the embodiment, in the multipoint teleconference system, a plurality of image synthesizers clustered with one another can share the image data sent from a plurality of conference terminals. This allows more conference terminals to have a conference than the conference terminals that the image synthesizer 110a can handle alone.

The image synthesizing unit 204 synthesizes image data in different screen layouts for each conference terminal using the decompressed image data based on the instruction from the controlling unit 202. The screen layout for each conference terminal will be explained later.

The image synthesizing unit 204 uses the image data received from the image-data communicating unit 203 as well as the image data decompressed by the image decompressing units 205a to 205e. The image data from the image-data communicating unit 203 is decompressed by the image decompressing units of the other image synthesizer 110b. In other words, the image synthesizer 110a synthesizes the image data of conference terminals that is not connected via the network 150 to it.

For example, it is assumed that the image synthesizer 110a is connected to the conference terminals 120a and 120b, and the clustered image synthesizer 110b is connected to the conference terminals 120c and 120d. The image synthesizer 110a receives the image data only from the conference terminals 120a and 120b. However, the image synthesizer 110a receives the decompressed image data of the conference terminals 120c and 120d from the image synthesizer 110b via the exclusive signal line. In this manner, the image synthesizer 110a synthesizes all the image data from the conference terminals 120a to 120d.

Because the image synthesizer 110b receives the decompressed image data of the conference terminals 120a and 120b from the image synthesizer 110a via the exclusive signal line, the image synthesizer 110b also synthesizes all the image data from the conference terminals 120a to 120d. In this manner, even if the conference terminals 120a to 120d are connected to different image synthesizers, a synthesized image of the conference terminals 120a to 120d participating in a single conference is generated.

The image compressing units 206a to 206e compress the image data synthesized by the image synthesizing unit 204 with respect to each conference terminal connected to the image synthesizer 110a. The image compressing units 206a to 206e compress the synthesized image data in a method appropriate to each conference terminal.

In other words, a single image compressing unit is dedicated to compress image data to be sent to a corresponding conference terminal. In this manner, the synthesized image data to be displayed in different layouts can be compressed in different compression coding methods or compression parameters with respect to each conference terminal.

For example, when the conference terminals 120a to 120d participate in a conference, the conference terminal 120a displays image data synthesized from the image data sent from the conference terminals 120b, 120c, and 120d, and the conference terminal 120b displays image data synthesized from the image data sent from the conference terminals 120a, 120c, and 120d.

Because each of the image compressing units 206a to 206e compresses image data of a single conference terminal, the compression coding method (for example, MPEG(Moving Picture Experts Group)-2, MPEG-4, H.263, H.264, and the like), the resolution, the frame rate, the bit rate, and the like can be set with respect to each conference terminal.

The image synthesizer 110a thereby generates and outputs image data in different layouts or image data compressed in different methods.

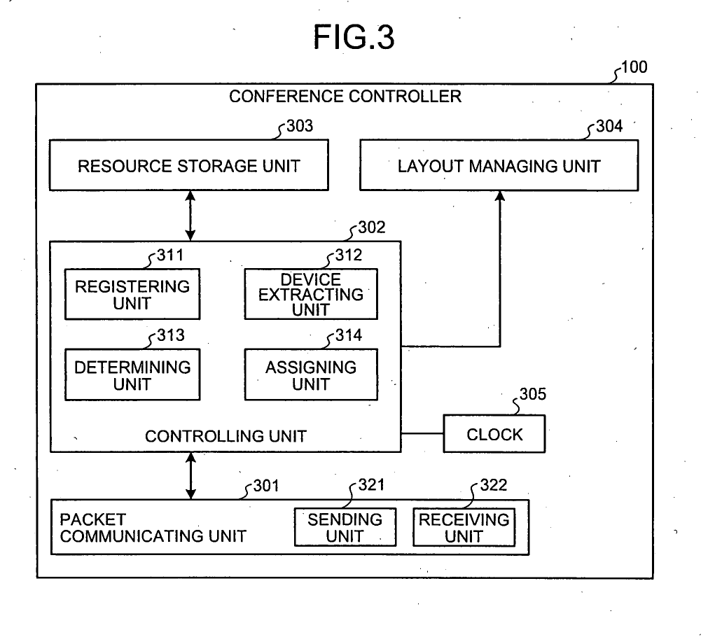

As shown in FIG. 3, the conference controller 100 includes a packet communicating unit 301, a controlling unit 302, a resource storage unit 303, a layout managing unit 304, and a clock 305. The conference controller 100 controls the image synthesizer registered to the resource storage unit 303, the connection between each conference terminal and the image synthesizer, the start of the conference, and the termination of the conference.

The conference controller 100 can control the screen layout of the synthesized image data. Each unit of the conference controller 100 can be realized by software.

The clock 305 measures the current time. The measured current time is used to control the time to start the conference and the like.

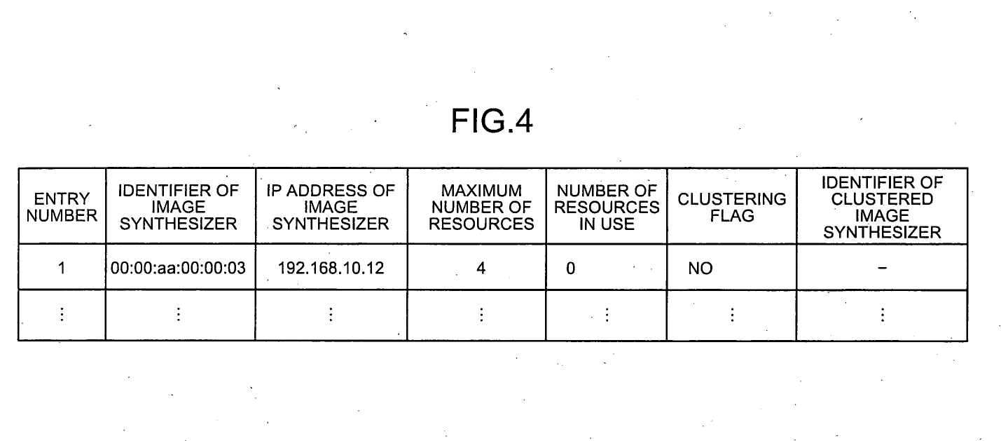

The resource storage unit 303 stores therein information of the image synthesizer that can perform the image synthesizing process. As shown in FIG. 4, a management table stored in the resource storage unit 303 associates an entry number, an identifier of the image synthesizer, an IP address of the image synthesizer, a maximum number of the resources, the number of the resources in use, a clustering flag, and an identifier of the clustered image synthesizer with one another. Each record is an entry indicative of registration of the image synthesizer.

The identifier of the image synthesizer uniquely identifies each image synthesizer. The identifier of the image synthesizer can be any kind of information that is guaranteed to be different from those of other image synthesizers. The MAC address assigned to the network interface of the image synthesizer is herein used as the identifier.

The IP address of the image synthesizer is used by each image synthesizer to communicate based on the IP. It can be used as self-ID (IDentification information).

The maximum number of the resources is the maximum number of the conference terminals that can be connected to the image synthesizer at the same time, which is five in the case of the image synthesizer 110a shown in FIG. 2. The maximum number of the resources is determined based on the hardware configuration of the image synthesizer and the like.

The number of the resources in use is the number of the resources consumed by the conference terminals currently connected to the image synthesizer. In general, one resource is consumed per conference terminal. However, more than one resource can be consumed if a single conference terminal participates in a plurality of conferences at a time. A difference between the maximum number of the resources and the number of the resources in use is an allowable number of the resources that can be used.

By storing the allowable number of the resources, upon receiving a request to start a conference from any one of the conference terminals 120a to 120d, the conference controller 100 specifies the image synthesizer that holds the conference. Moreover, the multipoint teleconference system according to the embodiment can hold a plurality of conferences within the allowable number of the resources.

The clustering flag indicates whether the image synthesizer is clustered with another image synthesizer.

The identifier of the clustered image synthesizer is the identifier of another image synthesizer clustered therewith, if the image synthesizer is clustered with the other image synthesizer. It uniquely identifies the clustered image synthesizer. The identifier is defined as the same information as the identifier of the image synthesizer described above. The MAC address assigned to the network interface of the clustered image synthesizer is herein used as the identifier of the clustered image synthesizer.

Returning to the explanation of FIG. 3, the packet communicating unit 301 includes a sending unit 321 and a receiving unit 322. The packet communicating unit 301 sends and receives various data, session control information for controlling the start and the termination of the conference between the image synthesizers 110a, 110b, and 110c and the conference terminals 120a to 120d, screen layout information for synthesizing the images, and other protocol information. The various data will be explained with the sending unit 321 and the receiving unit 322.

Like the image synthesizer 110a, the packet communicating unit 301 can use various communication protocols such as the SIP, the RTP/RTCP, the TCP/UDP, the IP, and the Ethernet (registered trademark).

The protocols used by the packet communicating unit 301 according to the embodiment comply with specifications of a conference system that uses image data, and other protocols can be used.

The receiving unit 322 receives the registration information from the image synthesizers 110a, 110b, and 110c, and receives a request for starting or terminating a conference from the conference terminals 120a to 120d.

The sending unit 321 sends information of whether the conference can start to the conference terminals 120a to 120d and sends information to identify a conference terminal to be connected thereto to the image synthesizer that synthesizes the image data. The processes performed by the receiving unit 322 and the sending unit 321 will be explained later in detail.

The controlling unit 302 includes a registering unit 311, a device extracting unit 312, a determining unit 313, and an assigning unit 314, and controls the entire conference controller 100.

The registering unit 311 registers the registration information received by the receiving unit 322 to the management table in the resource storage unit 303. In other words, the registering unit 311 registers the identifier of the image synthesizer, the IP address of the image synthesizer, the maximum number of the image synthesizers, the number of resources in use, the clustering flag, and the identifier of the clustered image synthesizer associated with one another to the management table. The maximum number of the resources can be stored in the conference controller 100 in advance, or it can be sent from the image synthesizer. The registering unit 311 sets zero to the number of the resources in use as an initial value. The clustering flag will be described later.

If the received registration information includes the identifier of the clustered image synthesizer, the determining unit 313 determines whether the clustered image synthesizer is already stored in the resource storage unit 303.

The determining unit 313 determines whether a combination of the identifier of the image synthesizer and the identifier of the clustered image synthesizer in the received registration information matches the same combination in any record stored in the resource storage unit 303.

More specifically, the determining unit 313 determines whether the identifier of the clustered image synthesizer is included in the field of the identifier of the image synthesizer in the management table. If it is included, the determining unit 313 determines whether the identifier of the image synthesizer in the received registration information is included in the field of the identifier of the clustered image synthesizer in the record that includes the identifier. If it is included, the determining unit 313 determines that the clustered image synthesizer is already registered.

If the received registration information does not include any identifier of the clustered image synthesizer, or if the determining unit 313 determines that the clustered image synthesizer is not registered, the registering unit 311 sets “no” to the clustering flag as the initial value.

If the determining unit 313 determines that the clustered image synthesizer is already registered to the management table, the registering unit 311 sets “yes” to the clustering flag. In this case, the registering unit 311 updates the clustering flag in the record of the clustered image synthesizer to “yes”. By processing in this manner, the clustering flag indicates “yes” only when the image synthesizers recognize the clustering with each other. By checking the clustering flag, each of the image synthesizers identifies the image synthesizer recognized to be clustered with each other. The clustering flag does not indicate “yes” by only one of the image synthesizers erroneously detecting the clustered image synthesizer. As a result, accuracy of extracting the image synthesizers clustered with each other is improved by checking the clustering flag.

If the entry of the image synthesizer in the received registration information is already registered to the management table, the registering unit 311 updates the management table using the received registration information. Therefore, the latest information is recorded in the management table.

Using a receipt of the request for starting the conference from any one of the conference terminals 120a to 120d as a trigger, the device extracting unit 312 extracts the identifier, the IP address, and the like of the image synthesizer used to start the conference from the management table.

When the device extracting unit 312 extracts the image synthesizer to start the conference, the controlling unit 302 performs control to start the conference session between the conference terminals and the image synthesizer.

As the trigger to start the conference, other processes can be used instead of the receipt of the request for starting the conference from the conference terminals 120a to 120d. For example, information reserved through a website can be used as the trigger to start the conference.

The assigning unit 314 determines the image synthesizer extracted by the device extracting unit 312 for assigning to synthesize images from conference terminals 120a to 120d.

The layout managing unit 304 manages the screen layout information to determine the layout of the image data for each of the conference terminals in the conference. The layout managing unit 304 outputs the screen layout information to the sending unit 321, and the sending unit 321 sends it to the image synthesizer. Therefore, the image synthesizer is controlled by the layout managing unit 304 to use the screen layout appropriate to each conference terminal to synthesize the image data.

In addition to direct control of the screen layout, the layout managing unit 304 can perform control based on a request from each conference terminal in the conference or an instruction from a conference terminal that leads the conference. The layout managing unit 304 can change the layout according to a voice detected from the conference terminal, i.e., a detected speaker. The layout managing unit 304 can control the screen layout based on an instruction from each conference terminal, if the image synthesizers 110a, 110b, and 110c send different synthesized image data with respect to each conference terminal.

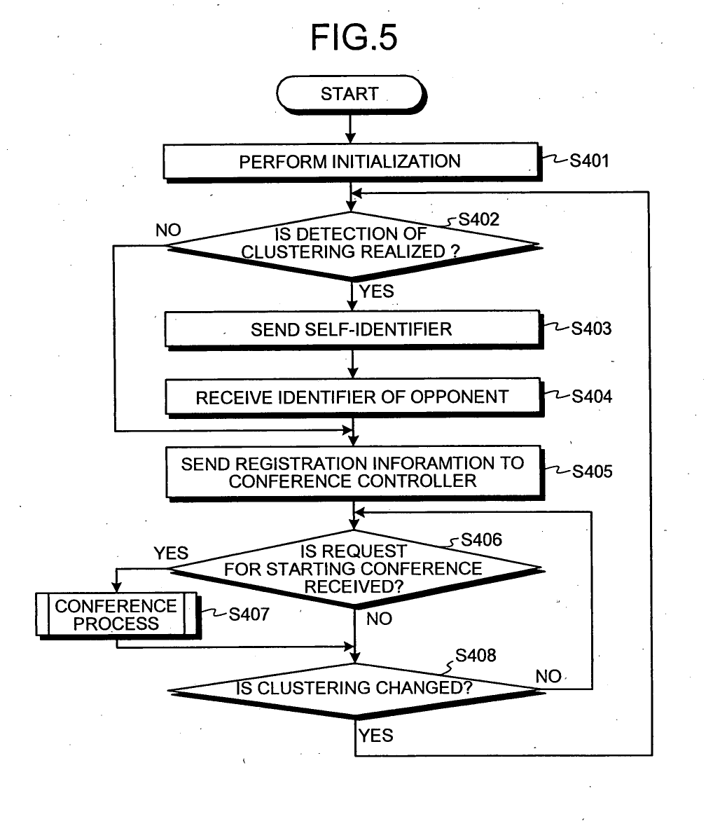

FIG. 5 is a flowchart of a registration process to the conference controller 100 performed by the image synthesizer 110a. Although the explanation is given based on the image synthesizer 110a, the same process is performed by other image synthesizers, and the explanation thereof is omitted.

Only by the registration from the image synthesizers 110a, 110b, and 110c, the conference controller 100 recognizes them. The recognition enables the conference controller 100 to connect the recognized image synthesizers 110a, 110b, and 110c to the conference terminals 120a to 120d and start the conference.

The controlling unit 202 of the image synthesizer 110a performs initial setting at the time of startup (step S401). The initial setting includes various network setup operations including setup of the IP address of the image synthesizer 110a and various hardware setup operations for the image synthesizer 110a. To set the network for the image synthesizer 110a including the IP address and a default gateway, information acquired from a dynamic host configuration protocol (DHCP) server can be set, or the setup can be made based on information manually set by an administrator in advance. The DHCP server can send information of the conference controller 100 to be connected including the IP address and the port number to the image synthesizer 110a in addition to the network information. By using the DHCP to connect the network in the multipoint teleconference system in this manner, the image synthesizer connected to the system is easily operated with reduced load on the administrator.

The detecting unit 211 detects a clustered image synthesizer from the image-data communicating unit 203 (step S402). The detection of the clustering is realized as a function of the image-data communicating unit 203. For example, there is a method in which, in the exclusive line 151 used for the clustering, an electric signal is low when the device is not connected, and the electric signal is pulled up high when the device is clustered and the exclusive line 151 is physically conducted. However, any other method can be used.

When the detecting unit 211 detects the clustered image synthesizer (YES at step S402), the image-data communicating unit 203 sends an identifier of the image synthesizer 110a to the clustered image synthesizer (step S403).

The image-data communicating unit 203 receives an identifier of the clustered image synthesizer from the clustered image synthesizer (step S404).

The sending unit 221 sends the registration information to the conference controller 100 (step S405). The registration information includes the identifier of the image synthesizer 110a, the IP address of the image synthesizer 110a, and the maximum number of the resources if no clustered image synthesizer is detected. If a clustered image synthesizer is detected, the registration information includes the identifier of the image synthesizer 110a, the IP address of the image synthesizer 110a, the maximum number of the resources, and the identifier of the clustered image synthesizer.

The conference controller 100 thereby registers the image synthesizer 110a as an entry. The message transmission at the time of the registration will be explained later in detail.

The receiving unit 222 determines whether a message is received from the conference controller 100 as a request for starting the conference (step S406). If it is not received (NO at step S406), no particular process is performed.

If the receiving unit 222 receives the message from the conference controller 100 (YES at step S406), a process for the conference is performed (step S407). The process performed for the conference based on the message of starting the conference will be explained later in detail.

The detecting unit 211 detects any change in configuration of the clustered image synthesizer (step S408). If there is no change (NO at step S408), the detecting unit 211 determines whether the request for starting the conference is received.

If the detecting unit 211 detects any change in the configuration of the clustered image synthesizer (YES at step S408), it determines again whether there is any clustering (step S402).

In the multipoint teleconference system according to the embodiment, the image synthesizers 110a, 110b, and 110c are automatically registered to the conference controller 100 in the process described above. Presence or absence of the clustering is also sent at the time of the registration. As a result, the conference controller 100 automatically recognizes the state of the image synthesizers 110a, 110b, and 110c including the presence of the clustering. The multipoint teleconference system reduces the workload of the administrator manually registering each of the image synthesizers.

If the clustering is changed according to the processing procedure, the clustering is immediately detected and the registration information indicative of the change of the clustering is sent. The registering unit 311 of the conference controller 100 updates the management table in the resource storage unit 303 with the received registration information. Therefore, the conference controller 100 always recognizes the latest state of the image synthesizer.

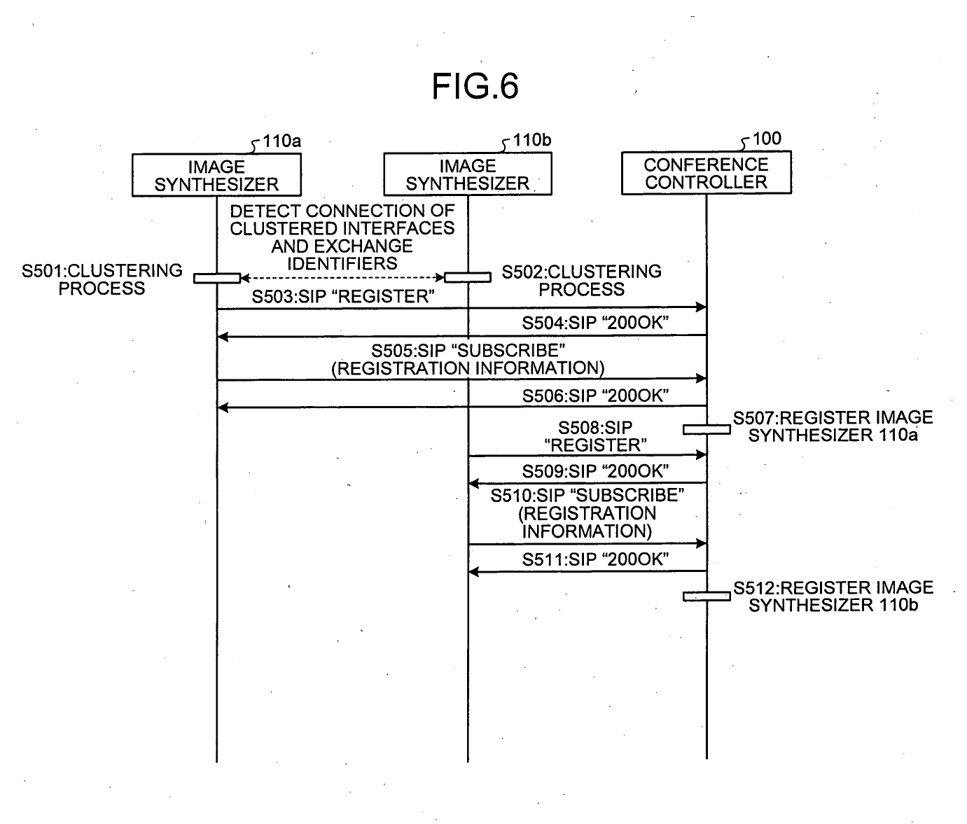

Message transmission by the conference controller 100 to register the image synthesizers 110a and 110b is explained below referring to FIG. 6.

In the explanation of the embodiment, the SIP is used for controlling various sessions including the registration, the start of the conference, and the termination of the conference performed between the image synthesizers 110a, 110b, and 110c and the conference controller 100. The SIP is used to control a call in an IP network, and it is standardized by the Internet Engineering Task Force (IETF). The embodiment is not limited to use the SIP for controlling the sessions, and any other controlling method can be used.

The image synthesizers 110a and 110b detect the clustering with each other at the time of the startup based on the procedure shown in FIG. 5, and exchange the identifiers (steps S501 and S502).

The image synthesizer 110a sends a “REGISTER” message to the conference controller 100 (step S503).

The conference controller 100 detects that the image synthesizer 110a requests registration by receiving the “REGISTER” message from the image synthesizer 110a. The conference controller 100 sends a “200OK” message indicative of success to the image synthesizer 110a (step S504).

By receiving the “200OK” message, the image synthesizer 110a recognizes that the request was accepted, and sends a “SUBSCRIBE” message to the conference controller 100 (step S505).

The “SUBSCRIBE” message is a request for notification of an event. It includes the registration information such as the identifier of the image synthesizer 110a (00:00:aa:00:00:01), the IP address of the image synthesizer 110a (192.168.10.10), the maximum number of the resources (5), and the identifier of the clustered image synthesizer 110b (00:00:aa:00:00:02).

Upon receiving the “SUBSCRIBE” message, the conference controller 100 sends the “200OK” message to the image synthesizer 110a (step S506).

The conference controller 100 registers the received registration information to the management table in the resource storage unit 303 (step S507). The information registered to the management table and the process of registering it will be described later.

The image synthesizer 110b sends the “REGISTER” message to the conference controller 100 (step S508).

When the conference controller 100 receives the “REGISTER” message from the image synthesizer 110b, the conference controller 100 recognizes that the image synthesizer 110b requests the registration. The conference controller 100 sends the “200OK” message to the image synthesizer 110b (step S509).

Upon receiving the “200OK” message, the image synthesizer 110b sends the “SUBSCRIBE” message to the conference controller 100 (step S510). The “SUBSCRIBE” message sent from the image synthesizer 110b includes the registration information such as the identifier of the image synthesizer 110b (00:00:aa:00:00:02), the IP address of the image synthesizer 110b (192.168.10.11), the maximum number of the resources (5), and the identifier of the clustered image synthesizer 110a (00:00:aa:00:00:01).

Upon receiving the “SUBSCRIBE” message, the conference controller 100 sends the “200OK” message to the image synthesizer 110b (step S511).

The conference controller 100 registers the received registration information to the management table (step S512). Because the clustered image synthesizer 110a is already registered in this case, the management table is updated with “yes” set to the clustering flag and the like. The registration process will be explained later in detail.

By performing the process described above, the conference controller 100 registers the information of the image synthesizers 110a and 110b to the resource storage unit 303 along with the information that they are clustered.

In the sequence diagram shown in FIG. 6, the steps S503 to S506 and the steps S508 to S511 are performed in order with respect to each device. However, the process is indicated in a simple manner for convenience of explanation, and it can be performed in different orders. For example, the process by the image synthesizer 110a and the conference controller 100 and the process by the image synthesizer 110b and the conference controller 100 can be independently performed in parallel with each other.

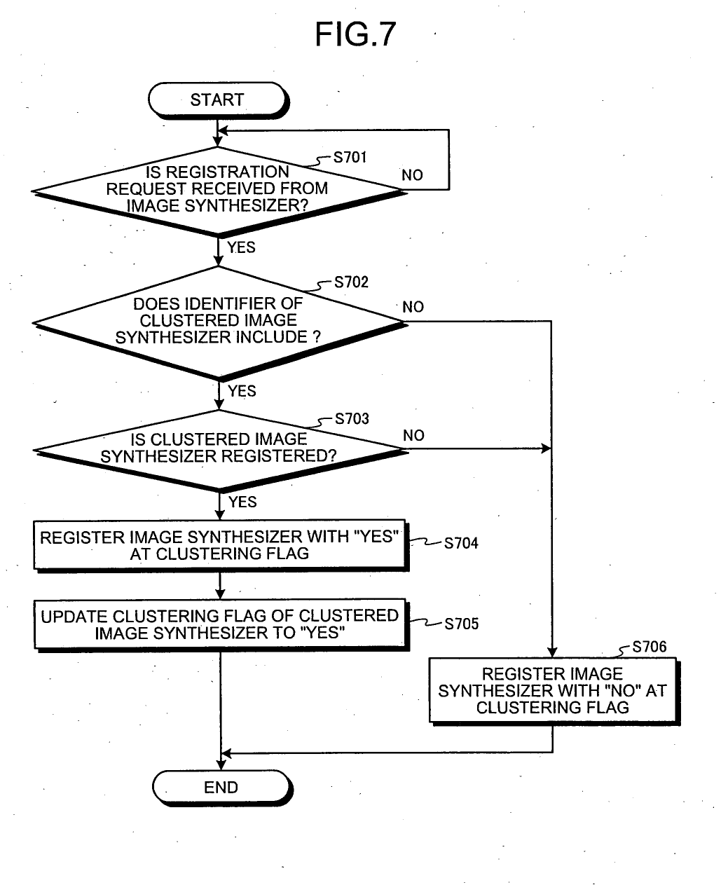

A flowchart of a process of registering information received from the conference controller 100 to the resource storage unit 303 is explained based on FIG. 7.

The receiving unit 322 in the conference controller 100 determines whether the registration information is received from any one of the image synthesizers (step S701). If the receiving unit 322 does not receive any registration information (NO at step S701), the receiving unit 322 repeats the step S701 until it receives the registration information. The receiving process corresponds to the receipt of the “SUBSCRIBE” message shown in FIG. 6. The conference controller 100 sends the “200OK” message (not shown).

If the receiving unit 322 receives the registration information (YES at step S701), the determining unit 313 determines whether the registration information includes the identifier of the clustered image synthesizer (step S702).

If the registration information includes the identifier of the clustered image synthesizer (YES at step S702), the determining unit 313 determines whether the clustered image synthesizer is registered to the management table as an entry (step S703). The determining unit 313 determines that the clustered image synthesizer is registered as the entry when it detects a record that includes the identifier of the clustered image synthesizer in the corresponding field of the management table.

For example, if the clustered image synthesizer is already registered as the entry at the step S703, the determining unit 313 determines whether the identifier of the clustered image synthesizer in the entry matches the identifier of the image synthesizer of which the registration information is sent. Only if they match, they both recognize the clustering with each other, and the process proceeds to a step S704.

If the registration information does not include the identifier of the clustered image synthesizer (NO at step S702) or if the entry of the clustered image synthesizer is not registered (NO at step S703), the registering unit 311 registers the identifier of the image synthesizer, the IP address of the image synthesizer, the maximum number of the resources, the number of the resources in use, the clustering flag “no”, and the identifier of the clustered image synthesizer in the registration information associated with one another (step S706). The identifier of the image synthesizer, the IP address of the image synthesizer, the maximum number of the resources, and the number of the resources in use are same as those used at the step S704. The identifier of the clustered image synthesizer is always registered if it is included in the registration information.

In the example shown in FIG. 4, the conference controller 100 cannot detect a record that includes the same identifier of the clustered image synthesizer 110b (00:00:aa:00:00:02) in the registration information from the image synthesizer 110a in the field of the identifier of the image synthesizer at the step S703. This means that an entry indicative of the clustered image synthesizer 110b is not registered. In such a case, the clustering flag is set to “no”.

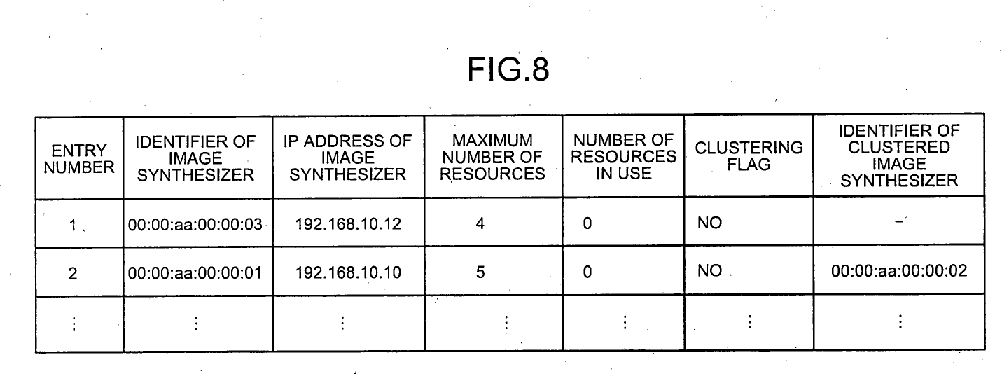

As shown in FIG. 8, in the management table after the entry of the image synthesizer 110a is registered, the clustering flag of the image synthesizer 110a is “no” because the entry of the image synthesizer 110b is not registered.

Returning to the explanation of FIG. 7, if the entry of the clustered image synthesizer is registered (YES at step S703), the registering unit 311 registers the identifier of the image synthesizer, the IP address of the image synthesizer, the maximum number of the resources, the number of the resources in use, the clustering flag “yes”, and the identifier of the clustered image synthesizer in the registration information associated with one another (step S704). The identifier of the image synthesizer, the IP address of the image synthesizer, the identifier of the clustered image synthesizer, and the maximum number of the resources are included in the registration information. The number of the resources in use is set to zero as an initial value.

The registering unit 311 updates the clustering flag of the entry of the clustered image synthesizer to “yes” in the management table (step S705).

In the example shown in FIG. 8, the conference controller 100 confirms at the step S703 that the identifier of the clustered image synthesizer 110a (00:00:aa:00:00:01) in the registration information of the image synthesizer 110b is registered to the management table as an entry (see an entry number 2 in the management table shown in FIG. 8). In such a case, the clustering flag of the image synthesizer 110b is set to “yes”. In this case, the clustering flag of the image synthesizer 110a is also updated to “yes”.

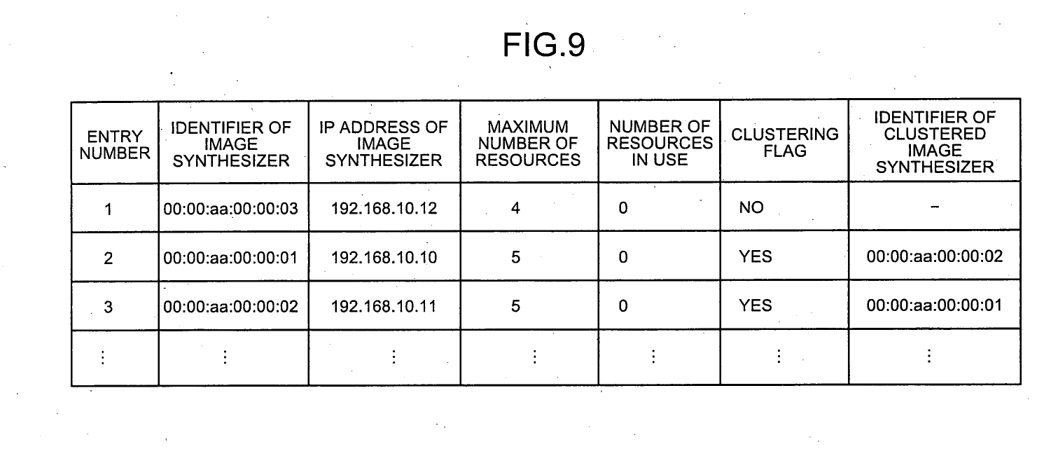

As shown in FIG. 9, in the management table after the entry of the image synthesizer 110b is registered, the clustering flag of the image synthesizer 110b is “yes” (see the entry number 3) because the entry of the image synthesizer 110a is already registered. The clustering flag of the image synthesizer 110a is also updated to “yes” (see the entry number 2).

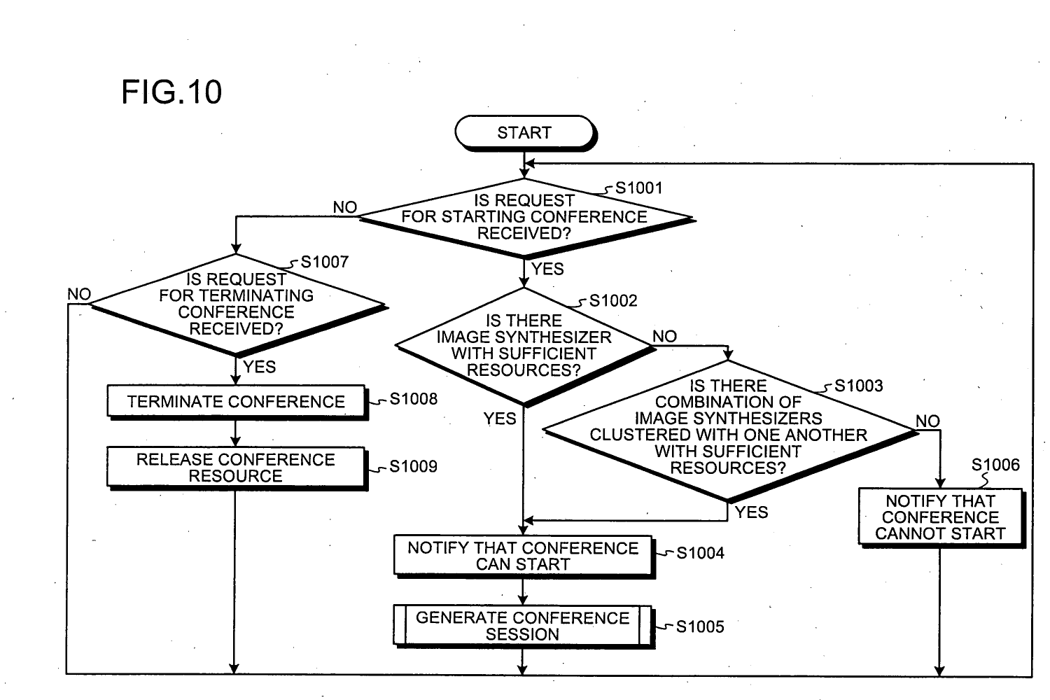

A flowchart of a process of the conference controller 100 starting and terminating a conference is explained using FIG. 10.

The receiving unit 322 in the conference controller 100 determines whether the request for starting a conference is received from a conference terminal (step S1001). The request for starting the conference herein includes the number of the resources required to start the conference.

If the request is received (YES at step S1001), the device extracting unit 312 extracts an image synthesizer that can spare the required number of the resources in the request from the management table (step S1002).

If the device extracting unit 312 cannot extract the image synthesizer that can spare the required number of the resources (NO at step S1002), the device extracting unit 312 extracts a plurality of image synthesizers clustered with each other that can spare the required number of the resources from the management table (step S1003). In other words, though the conference cannot be held with a single image synthesizer, the device extracting unit 312 determines whether the conference can be held by combining a plurality of the image synthesizers. For example, if the total number of the resources of available image synthesizers clustered with each other is larger than the number of the resources in the request for starting the conference, the image synthesizers are extracted. The image synthesizers share the processes to start the conference.

If the device extracting unit 312 extracts one or more image synthesizers that can spare the number of the resources in the request (YES at step S1002 or S1003), the sending unit 321 sends a message that the conference can start to the conference terminal that requested to start the conference (step S1004). The conference controller 100 then generates a session to start the conference (step S1005).

If the device extracting unit 312 cannot extract a plurality of the image synthesizers (NO at step S1003), the sending unit 321 sends a message that the conference cannot be held to the conference terminal (step S1006).

If the received information is not a request for starting a conference (NO at step S1001), the receiving unit 222 determines whether the received information is a request for terminating the conference (step S1007).

If the received information is the request for terminating the conference (YES at step S1007), the conference controller 100 performs control to terminate the current conference (step S1008). The controlling unit 302 performs a process to reduce the number of the resources consumed by the conference in the entry of the image synthesizer used to hold the conference in the management table (step S1009). At this point, the conference resource is released.

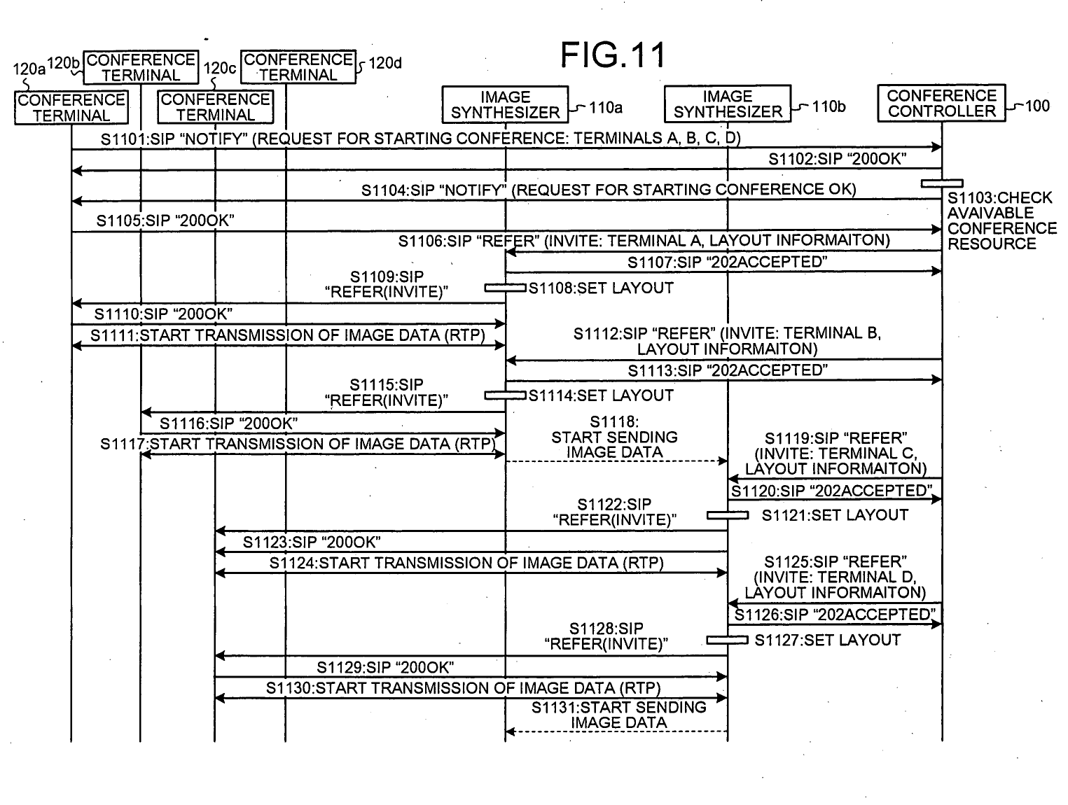

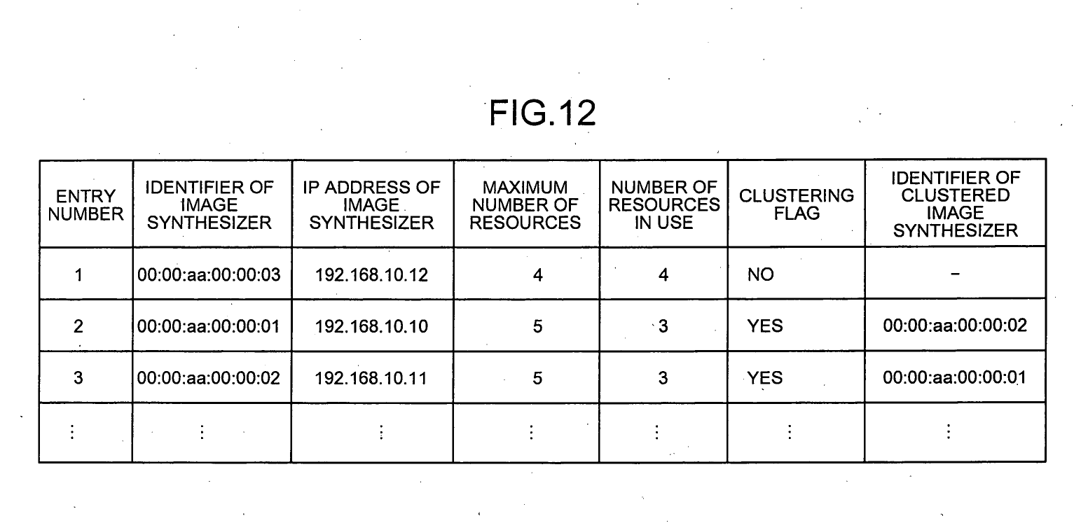

The message transmission by the conference controller 100 when the image synthesizers 110a and 110b synthesize image data in response to the request for starting a conference from the conference terminals 120a to 120d is explained below referring to FIGS. 11 and 12.

As shown in FIG. 12, according to the management table before the process shown in FIG. 11 is performed, all the resources of the image synthesizer 110c with the entry number 1 are consumed. In the image synthesizer 110a with the entry number 2, the maximum number of the resources is five, the number of the resources in use is three, and therefore the extra number of the resources is two. Similarly, in the image synthesizer 110b with the entry number 3, the maximum number of the resources is five, the number of the resources in use is three, and therefore the extra number of the resources is two. The image synthesizers 110a and 110b are clustered with each other.

In other words, none of the image synthesizers can hold a conference among more than two conference terminals alone; however, a conference can be held among up to four conference terminals by the image synthesizers 110a and 110b sharing the synthesizing process. In this case, if the conference controller 100 receives the request for starting the conference from more than four conference terminals, it returns a message that the conference cannot be held because sufficient resources cannot be acquired even by using the clustering.

Although the SIP is used as a transmission control protocol in the sequence diagram shown in FIG. 11, the transmission control protocol is not limited to the SIP.

The conference terminal 120a sends a request for starting a conference with the conference terminals 120b, 120c, and 120d to the conference controller 100 (step S1101). The conference terminal 120a sends a “NOTIFY” message indicative of transmission of notification of the requested event as the request for starting the conference. The request can be sent from another conference terminal instead of the conference terminal 120a.

The conference can be started using another incident as a trigger instead of the request sent from the conference terminal to the conference controller 100. For example, in the case of a scheduled conference, the conference controller 100 can perform control to start the conference when the current time reaches the starting time of the scheduled conference stored in the conference controller 100. Such a configuration naturally requires the clock 305 in the conference controller 100 to measure the current time. Because the conference is scheduled in advance, the conference is held with reduced load of a user and the resources to hold the conference can be saved in advance.

The conference controller 100 sends the “200OK” message to the conference terminal 120a for confirmation (step S1102).

The conference controller 100 extracts an image synthesizer with available resources (step S1103). For example, with the conference resources shown in FIG. 12, the device extracting unit 312 recognizes that a new conference can start by combining the remaining resources of the image synthesizers 110a and 110b that are clustered with each other. If the device extracting unit 312 recognizes that a new conference can start, the controlling unit 302 increases the consumed number of the resources in the corresponding record in the management table. The assigning unit 314 assigns the image synthesizer 110a for the conference terminals 120a and 120b, and it assigns the image synthesizer 110b for the conference terminals 120c and 120d.

To notify that the conference can be held, the sending unit 321 sends a “NOTIFY” message that indicates the conference can start to the conference terminal 120a (step S1104). If there are not sufficient resources to start the conference, the sending unit 321 sends a “NOTIFY” message that indicates the conference cannot start.

Upon receiving the “NOTIFY” message, the conference terminal 120a sends the “200OK” message to the conference controller 100 for confirmation (step S1105).

The conference controller 100 sends a “REFER(INVITE)” message to the image synthesizer 110a to establish a session between the image synthesizer 110a and the conference terminal 120a (step S1106). The “REFER” message is referred to as a third-party call control, which is used by the conference controller 100 as the third party to control the establishment and the termination of the session between the image synthesizer 110a and the conference terminal 120a.

Upon receiving the “REFER(INVITE)” message, the sending unit 221 of the image synthesizer 110a sends a “202ACCEPTED” message to the conference controller 100 (step S1107).

The controlling unit 202 sets screen layout information for synthesizing the image in the “REFER(INVITE)” message to the image synthesizing unit 204 (step S1108).

Because the received “REFER(INVITE)” message includes an instruction to the image synthesizer 110a to be connected to the conference terminal 120a, the sending unit 221 sends an “INVITE” message to the conference terminal 120a to establish a session between the image synthesizer 110a and the conference terminal 120a (step S1109).

Upon receiving the “INVITE” message, the conference terminal 120a sends the “200OK” message to the image synthesizer 110a (step S1110). The conference terminal 120a starts to exchange image data with the image synthesizer 110a based on the RTP (step S1111). The “INVITE” message can include various parameters of the image data such as the compression coding method, the resolution, the frame rate, and the bit rate.

Similarly, based on the third-party call control from the conference controller 100, the session is established and the image is exchanged between the image synthesizer 110a and the conference terminal 120b (steps S1112 to S1117).

The image synthesizer 110a thereby acquires the image data from the conference terminals 120a and 120b. After the image synthesizer 110a decompresses the received image data, the image-data communicating unit 203 of the image synthesizer 110a starts to send the decompressed image data to the image synthesizer 110b (step S1118). However, not all of the decompressed image data need to be sent to the image synthesizer 110b. For example, the image-data communicating unit 203 can send only image data requested by the image synthesizer 110b.

The conference controller 100 sends a “REFER(INVITE)” message to establish a session between the image synthesizer 110b and the conference terminal 120c (step S1119).

Upon receiving the “REFER(INVITE)” message, the sending unit 221 of the image synthesizer 110b sends the “202ACCEPTED” message to the conference controller 100 (step S1120).

The controlling unit 202 of the image synthesizer 110b sets screen layout information in the “REFER(INVITE)” message for synthesizing the image to the image synthesizing unit 204 (step S1121).

Because the received “REFER(INVITE)” message includes an instruction to be connected to the conference terminal 120c, the sending unit 221 of the image synthesizer 110b sends the “INVITE” message to the conference terminal 120c to establish a session with the conference terminal 120c (step S1122).

Upon receiving the “INVITE” message, the conference terminal 120c sends the “200OK” message to the image synthesizer 110b (step S1123). The conference terminal 120c starts to exchange image data with the image synthesizer 110b based on the RTP (step S1125).

Similarly, based on the third-party call control from the conference controller 100, the session is established and the image is exchanged between the image synthesizer 110b and the conference terminal 120d (steps S1126 to S1130).

The image synthesizer 110b thereby acquires the image data from the conference terminals 120c and 120d. After the image synthesizer 110b decompresses the received image data, the image-data communicating unit 203 of the image synthesizer 110b starts to send the decompressed image data to the image synthesizer 110a (step S1131). However, not all of the decompressed image data need to be sent to the image synthesizer 110a. For example, the image-data communicating unit 203 can send only image data requested by the image synthesizer 110a.

According to the procedure described above, the conference can be held among the conference terminals 120a to 120d. The conference terminals 120a and 120b are connected to the image synthesizer 110a, and the conference terminals 120c and 120d are connected to the image synthesizer 110b. In other words, the image synthesizers 110a and 110b receive difference image data via the network 150. However, the image synthesizers 110a and 110b exchange decompressed image data via the exclusive line 151. Therefore, the image data synthesized by the image synthesizing unit 204 in each image synthesizer to be sent to other image synthesizers includes all of the images of the conference terminals 120a to 120d.

In the sequence diagram shown in FIG. 11, the steps S1106 to S1111, the steps S1112 to S1117, the steps S1119 to S1124, and the steps S1125 to S1130 are performed in order with respect to each device. However, the process is indicated in a simple manner for convenience of explanation, and it can be performed in different orders. More specifically, the process performed by the image synthesizer 110a, the conference controller 100, and the corresponding conference terminals and the process performed by the image synthesizer 110b, the conference controller 100, and the corresponding conference terminals are independently performed in parallel with each other.

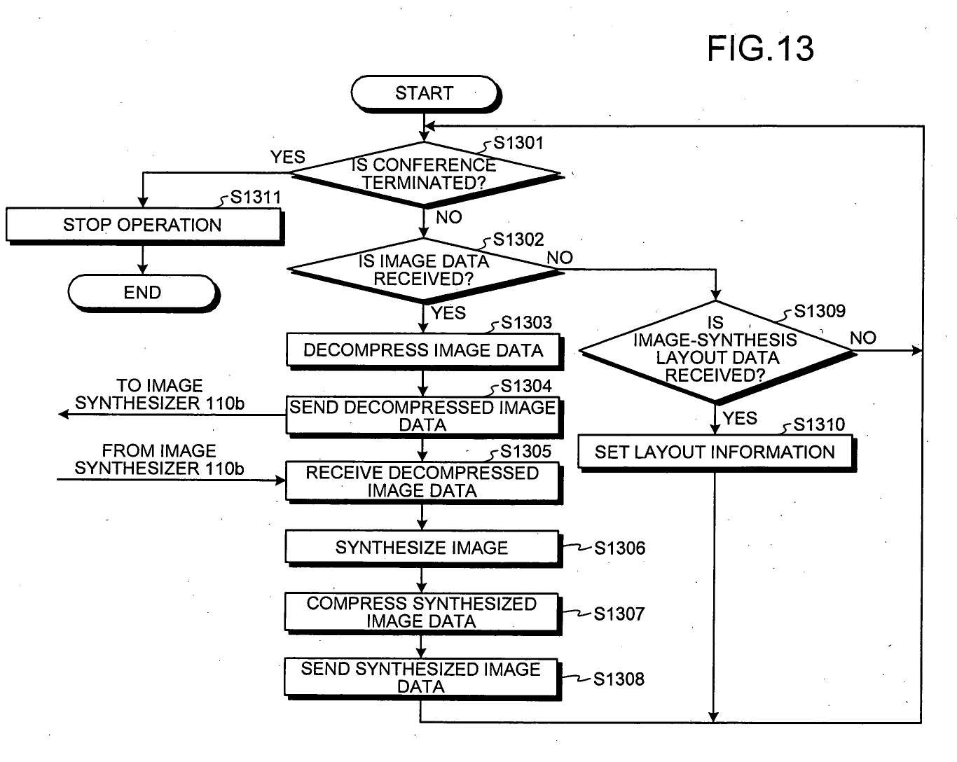

FIG. 13 is a flowchart of a process of synthesizing the image data from the conference terminals when the image synthesizer 110a is clustered with the image synthesizer 110b to share the decompression and the compression of the image data. The image synthesizers 110b and 110c can perform the same process when they are clustered with each other, and the explanation thereof is omitted.

The controlling unit 202 of the image synthesizer 110a determines whether the conference is terminated (step S1301). The conference is terminated, for example, when the receiving unit 222 receives a request for terminating the conference.

If the conference is not terminated (NO at step S1301), the controlling unit 202 determines whether the received information is image data from the connected conference terminals (step S1302).

If the received information is the image data (YES at step S1302), one of the image decompressing units 205a to 205e in charge of the image data decompresses the received image data (step S1303).

If the clustered image synthesizer 110b operates the same conference, the image-data communicating unit 203 sends the decompressed image data (step S1304). In this case, the image-data communicating unit 203 receives the decompressed image data (step S1305).

The image synthesizing unit 204 of the image synthesizer 110a synthesizes the decompressed image data to generate a single image data with respect to each conference terminal (step S1306). The image layout will be described later.

Each of the image compressing units 206a to 206e of the image synthesizer 110a compresses the synthesized image data (step S1307).

The sending unit 221 sends the compressed image data with respect to each conference terminal (step S1308).

The controlling unit 202 determines whether the receiving unit 222 has received the screen layout for synthesizing the images (step S1309). If the screen layout is received (YES at step S1309), the controlling unit 202 sets the layout information to the image synthesizing unit 204 (step S1310).

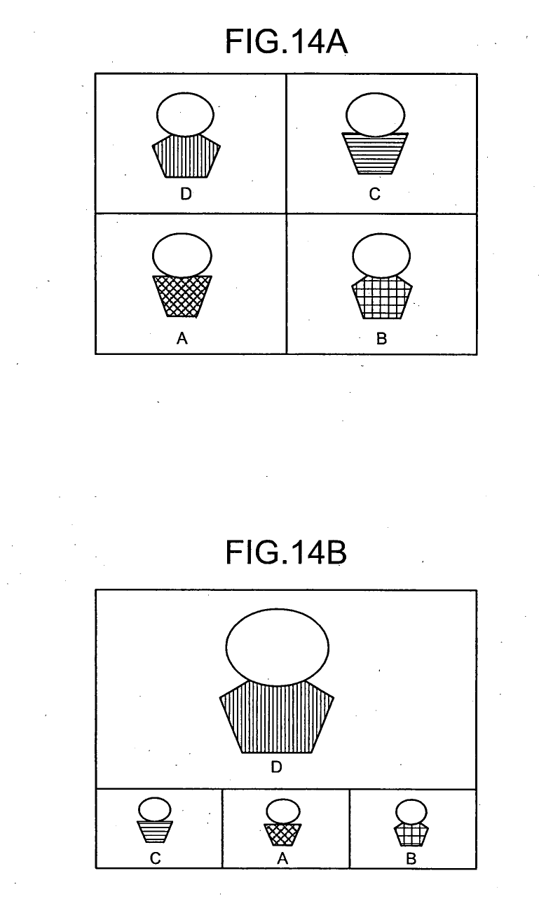

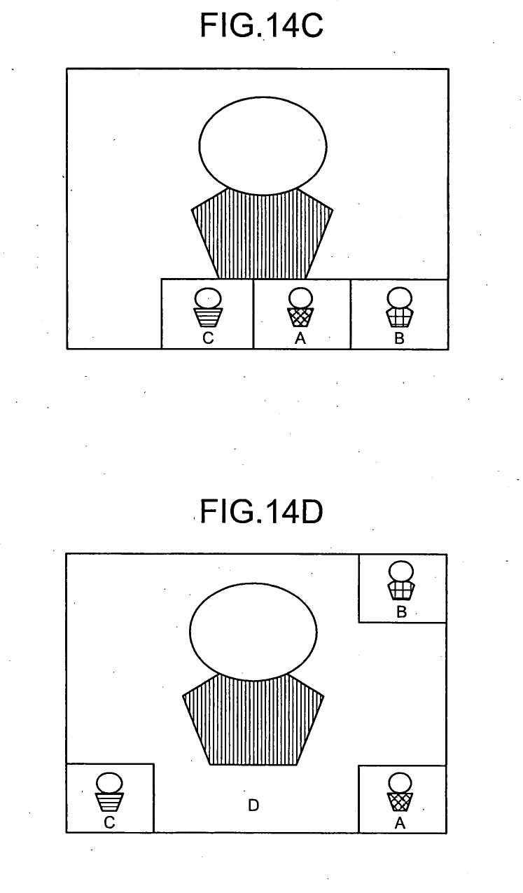

The screen layout shown in FIG. 14A is realized by the controlling unit 202 setting as described above. The screen layout is not limited to the example shown in FIG. 14A. For example, when a speaker is detected, an image of the speaker can be enlarged.

As shown in FIG. 14B, the image data of the conference terminal 120d used by a participant D, who is the speaker, is enlarged and images of participants A to C can be shrunk to be displayed at the bottom.

In an example shown in FIG. 14C, the images of the participants A to C are shrunk more than those in the example shown in FIG. 14B.

In an example shown in FIG. 14D, the images of the participants A to C are shrunk and displayed at the corners. As shown in FIGS. 14A to 14D, the screen layout can change as needed. The screen layout is not limited to those described above, and any other layout can be used.

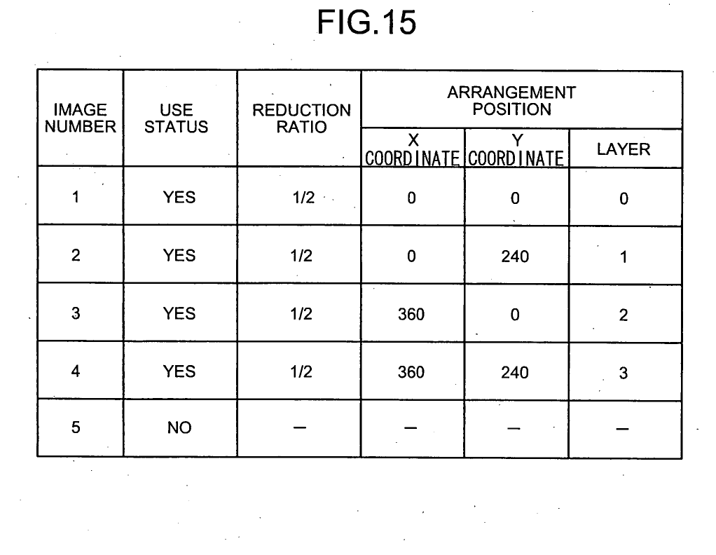

To set a layout, layout information is used. The layout information is sent from the conference controller 100 and stored in the controlling unit 202. As shown in FIG. 15, an image number, a use status, a reduction ratio, and an arrangement position are associated with one another in the layout information with respect to each conference terminal. The information includes five images because the image synthesizer can connect five conference terminals.

In FIG. 15, screen size of the conference terminal is assumed 720×480 dots. Images 1 to 4 to be input to the image synthesizer hold a single conference, and therefore, the use status of the image data 1 to 4 indicates “yes”. The layout information is based on the quartered layout as shown in FIG. 14A. The arrangement position in the layout information includes layer information as well as an X coordinate and a Y coordinate as an origin. The layer information indicates priority to be displayed. It indicates which image data has a higher priority to be displayed when the images are superposed.

According to the embodiment, because the image data is synthesized with respect to each conference terminal, self-image data can be excluded. For example, when there are the participants A to D, the image data to be sent to the participant A can be synthesized to display only the participants B to D.

Moreover, according to the embodiment, because the image data is synthesized based on the layout information for each conference terminal regardless of the image synthesizer, the image data is provided in any layout as the user likes.

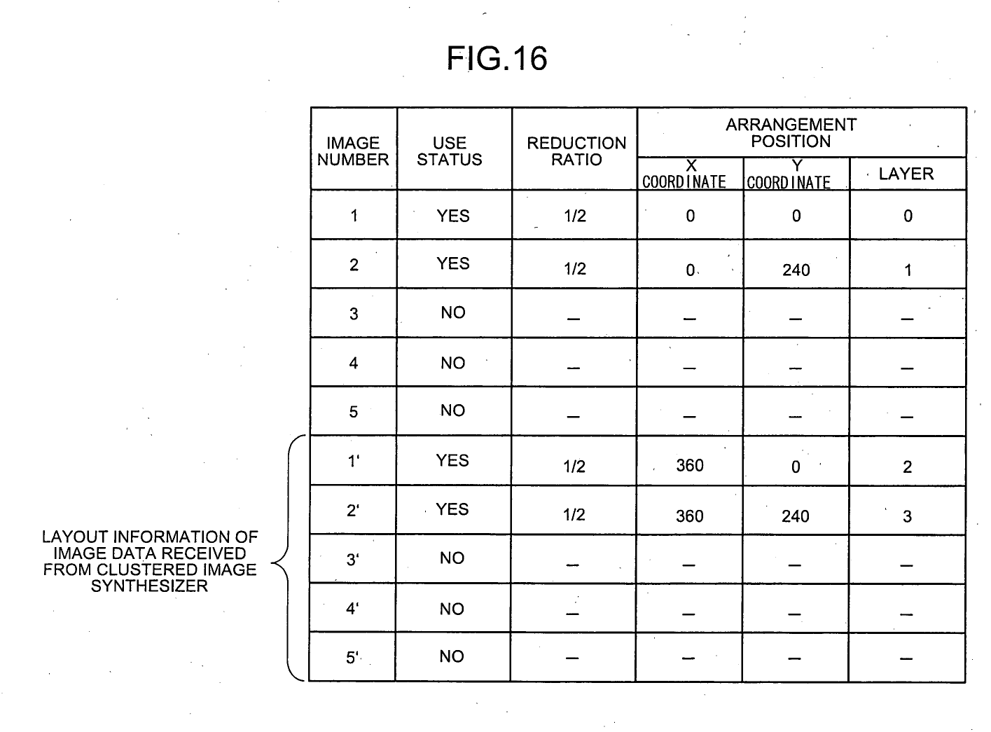

A data configuration of the layout information shown in FIG. 16 when the image synthesizer is clustered with another includes the same fields as the layout information shown in FIG. 15; however, the number of the images is different. In other words, the image data can be synthesized using five image data from the image synthesizer and five image data from the clustered image synthesizer. The layout information is based on the quartered layout using the image data 1 and 2 from the image synthesizer and image data 1′ and 2′ from the clustered image synthesizer.

By setting the layout information in this manner, the image data can be synthesized in a layout proper to each conference terminal.

Returning to the explanation of FIG. 13, if the conference terminates (YES at step S1301), the controlling unit 202 of the image synthesizer 110a performs control to stop the conference (step S1311).

By performing the process as described above, the image synthesizers 110a, 110b, and 110c synthesize image data received from the connected conference terminals based on the layout information, and send the image data in the layout proper to each conference terminal. When the image synthesizer does not share the decompression and the compression of the image data with another image synthesizer, the image-data communicating unit 203 does not send or receive the image data at the steps S1304 and S1305; however, other processes are performed as described above.

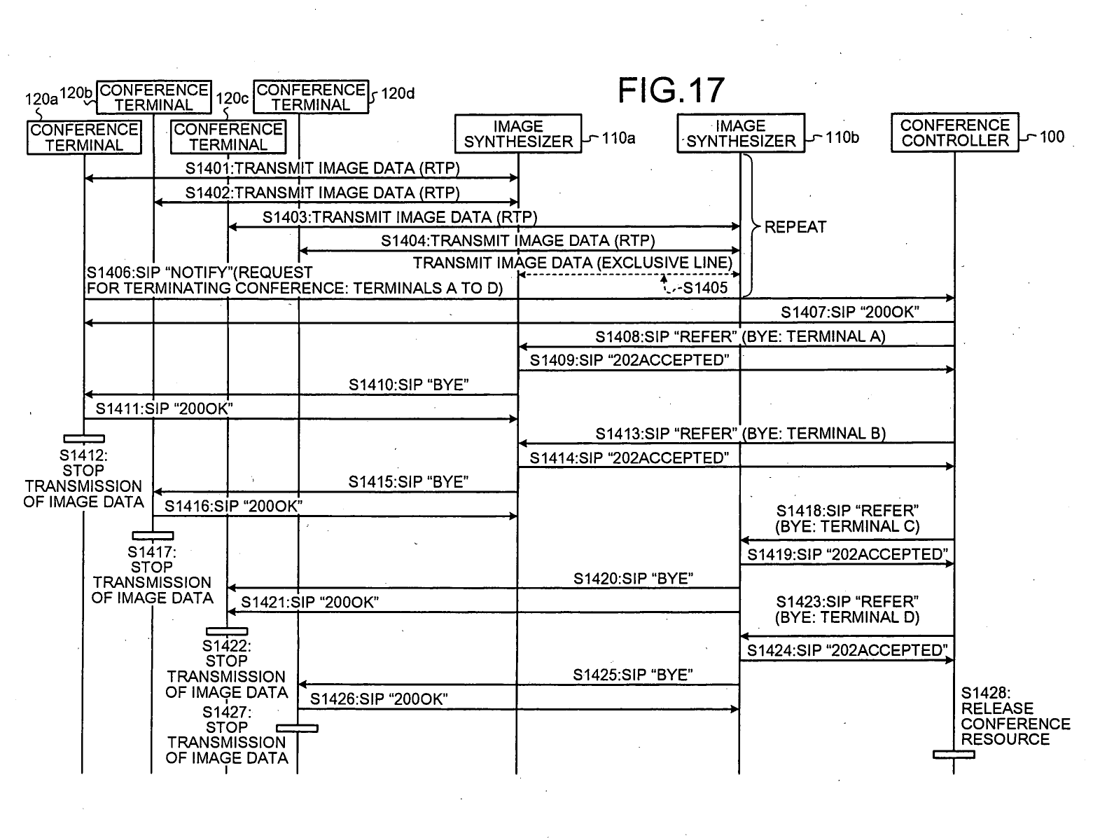

Message transmission performed when the multipoint teleconference system according to the embodiment terminates a conference is explained referring to FIG. 17.

The explanation is given assuming that the conference terminal 120a sends a request for terminating the conference among the conference terminals 120a to 120d to the conference controller 100; however, the message transmission is not limited to such a case. For example, another conference terminal can send the request instead of the conference terminal 120a. Otherwise, the conference can be terminated using another incident as a trigger instead of one of the conference terminals 120a to 120d sending the request to the conference controller 100. For example, the conference controller 100 can perform control to terminate the conference when the current time reaches the termination time of the scheduled conference stored in the conference controller 100 or the like.

Although the SIP is used as the transmission control protocol in the sequence diagram shown in FIG. 17, it is not limited to use the SIP.

During the conference, the conference terminals 120a and 120b exchange image data with the connected image synthesizer 110a (steps S1401, S1402). The conference terminals 120c and 120d exchange image data with the connected image synthesizer 110b (steps S1403, S1404). Decompressed image data is also exchanged between the image synthesizers 110a and 110b that are clustered with each other (step S1405).

The conference terminal 120a sends a “NOTIFY” message indicative of a request for terminating the conference among the conference terminals 120a to 120d to the conference controller 100 (step S1406).

The sending unit 321 in the conference controller 100 sends the “200OK” message to the conference terminal 120a for confirmation (step S1407).

The sending unit 321 sends a “REFER(BYE)” message to terminate the session between the image synthesizer 110a and the conference terminal 120a (step S1408).

Upon receiving the “REFER(BYE)” message, the controlling unit 202 of the image synthesizer 110a sends the “202ACCEPTED” message to the conference controller 100 (step S1409).

Because the “REFER(BYE)” message instructs termination of the session between the image synthesizer 110a and the conference terminal 120a, the image synthesizer 110a sends a “BYE” message to the conference terminal 120a to terminate the session with the conference terminal 120a (step S1410).

Upon receiving the “BYE” message, the conference terminal 120a sends the “200OK” message to the image synthesizer 110a (step S1411).

The conference terminal 120a thereby stops the exchange of the image data with the image synthesizer 110a based on the RTP (step S1412).

By performing a process similar to the steps S1408 to S1412, the conference controller 100 performs the third-party call control to terminate a session between the image synthesizer 110a and the conference terminal 120b and stop the transmission of the image data (steps S1413 to S1416).

The sending unit 321 sends a “REFER(BYE)” message to terminate a session between the image synthesizer 110b and the conference terminal 120c (step S1418).

Upon receiving the “REFER(BYE)” message, the controlling unit 202 of the image synthesizer 110b sends the “202ACCEPTED” message to the conference controller 100 (step S1419).

Because the image synthesizer 110b is instructed by the received “REFER(BYE)” message to terminate the session with the conference terminal 120c, it sends the “BYE” message to the conference terminal 120c to terminate the session (step S1420).

Upon receiving the “BYE” message, the conference terminal 120c sends the “200OK” message to the image synthesizer 110b (step S1421).

The conference terminal 120c thereby stops the exchange of the image data with the image synthesizer 110b based on the RTP (step S1422).

By performing a process similar to the steps S1418 to S1422, the conference controller 100 performs the third-party call control to terminate a session between the image synthesizer 110b and the conference terminal 120d and stop the transmission of the image data (steps S1423 to S1427).

The conference controller 100 releases the conference resources that were used for the conference (step S1428). For example, the controlling unit 302 reduces the numbers of the resources of the image synthesizers 110a and 110b in use by two, respectively.

With the procedure described above, the conference among the conference terminals 120a to 120d is terminated. In the sequence diagram shown in FIG. 17, the termination process is performed in order with respect to each device at the steps S1408 to S1412, the steps S1413 to S1417, the steps S1418 to S1422, and the steps S1423 to S1427. However, the process is indicated in the order for convenience of explanation, and it can be performed in different orders. For example, the process between the image synthesizer 110a and the conference controller 100 and the process between the image synthesizer 110b and the conference controller 100 are independently performed in parallel with each other.

The image synthesizers 110a, 110b, and 110c decompress, synthesize, and compress the image data received from a plurality of conference terminals. However, considering an amount of the image data to be processed and the number of the steps performed in the process, it is difficult to perform the process by software using a single central processing unit (CPU). The functions of the image synthesizers 110a, 110b, and 110c according to the embodiment can be realized using hardware.

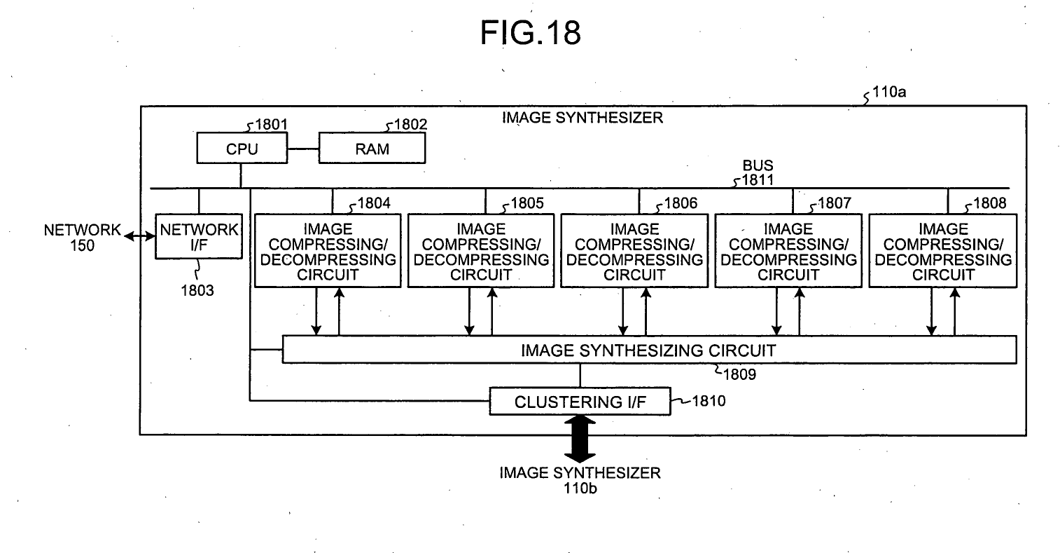

As shown in FIG. 18, the image synthesizer 110a includes a CPU 1801, a random access memory (RAM) 1802, a network interface (network I/F) 1803, image compressing/decompressing circuits 1804 to 1808, an image synthesizing circuit 1809, a clustering interface (clustering I/F) 1810, and a bus 1811 that connects the units.

The image decompressing units 205a to 205e and the image compressing units 206a to 206e are realized by the image compressing/decompressing circuits 1804 to 1808. Image-compressing circuits and image-decompressing circuits can be realized by separate circuits. The image synthesizing unit 204 is realized by the image synthesizing circuit 1809.

The packet communicating unit 201 controls transmission of information via the network I/F 1803 (for example, a network interface based on a 100 Mbps Ethernet (registered trademark)). The image-data communicating unit 203 controls transmission of image data and the like via the clustering I/F 1810.

The controlling unit 202 is realized by software using the CPU 1801 and the RAM 1802 that is used by the CPU 1801.

The bus 1811 (for example, a PCI (Peripheral Component Interconnect)) connects the CPU 1801, the image compressing/decompressing circuits 1804 to 1808, the image synthesizing circuit 1809, and the network I/F 1803. Although the units are connected with a single bus in FIG. 18, they can be connected with a plurality of buses at different bit rates via a bus bridge.

The image synthesizing circuit 1809 is connected to the image compressing/decompressing circuits 1804 to 1808 using a bus to exchange uncompressed image data (for example, ITU-R BT.656 bus).

Each of the internal bus interfaces is specified by a design guide.

The clustering I/F 1810 is an exclusive signal line to transmit a necessary amount of the compressed image data as required for the synthesizing process in real time. According to the embodiment, the clustering I/F 1810 is an about 10 Gbps signal line based on a low voltage differential signaling (LVDS). The amount of the uncompressed image data for the conference terminals can be thereby transmitted between the clustered image synthesizers after the image data is decoded with a standard definition quality at about 250 Mbps. However, the signal line is not limited to the LVDS.

Although the image data is transmitted using the clustering I/F 1810 according to the embodiment, the data to be transmitted can include other data than the image data. As described above, the clustering I/F 1810 reliably communicates at a higher speed than the network I/F 1803. For example, the clustering I/F 1810 reliably transmits uncompressed image data that the network I/F 1803 cannot handle due to lack of the bit rate.

Otherwise, the entire image synthesizer can be realized by a computer program.

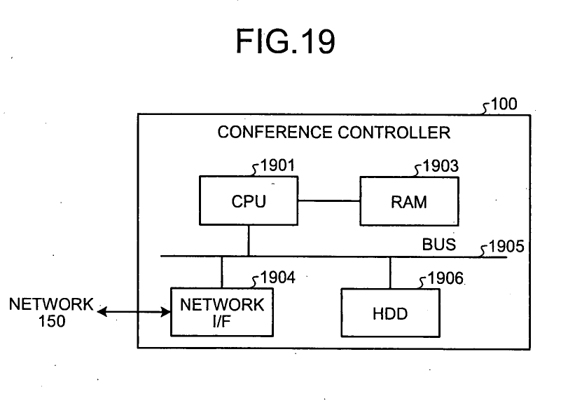

As shown in FIG. 19, the conference controller 100 includes a CPU 1901, a RAM 1903, a network I/F 1904, a hard disk drive (HDD) 1906, and a bus 1905, as the hardware. The CPU 1901 controls each unit of the conference controller 100 according to a program in the HDD 1906. The RAM 1903 stores therein various data required to control the conference controller 100. The network I/F 1904 is connected to the network 150 for communication. The HDD 1906 stores therein a conference controlling program and various types of information. The bus 1905 connects the units in the conference controller 100. The conference controller 100 can be realized by a common computer configured as described above.

The conference controlling program executed by the conference controller 100 according to the embodiment is recorded in a computer-readable recording medium such as an HDD, a compact disk read only memory (CD-ROM), a flexible disk (FD), a compact disk readable (CD-R), and a digital versatile disk (DVD) in an installable or executable format.

In this case, when the conference controller 100 reads the conference controlling program from the recording medium and executes it, the conference controlling program is loaded into a main storage unit and the controlling unit 302 is generated in the main storage unit. The resource storage unit 303 and the layout managing unit 304 are stored in the main storage unit at the time of executing the conference controlling program.

The conference controlling program can be stored in a computer connected to a network such as the Internet to be provided by downloading it via the network. The conference controlling program can be provided or distributed via the network.

The conference controlling program according to the embodiment can be recorded in a ROM and the like to be provided.

The conference controlling program includes modules of the units described above. When a CPU reads the conference controlling program from the recording medium and executes it, the units are loaded into the main storage unit and generated in it.

The image synthesizers are not limited to be clustered one-to-one, and they can be clustered one-to-n.

The embodiment was explained assuming that the multipoint teleconference system uses image data. Communication via the exclusive line for the clustering is even more effective when the transmitted data is large as the image data. However, the multipoint teleconference system according to the embodiment is not limited to transmission of the image data, and it can be configured to transmit various media data such as sound data and application data including a text chat application and a spreadsheet.

According to the embodiment, the conference controller 100 stores the registration information sent from an image synthesizer in the resource storage unit 303. The conference controller 100 assigns an image synthesizer appropriate to the conference based on the registration information when it receives a request for starting a conference from a conference terminal. If it is registered that image synthesizers are clustered, the conference controller 100 automatically controls the clustered image synthesizers to hold the conference. In this manner, the administrator does not need to manually perform setup, which reduces the workload of the setup to realize the multipoint conference.

Moreover, in the multipoint teleconference system according to the embodiment, without the administrator's operation, the conference controller 100 registers the image synthesizers and controls to hold a multipoint teleconference taking advantage of resources of the image synthesizers.

The present invention is not limited to the embodiment described above, and it can be carried out in various modifications as described below.

The image synthesizers 110a, 110b, and 110c according to the embodiment include the same number of the image compressing units 206a to 206e as the maximum number of the resources; however, the number of the image compressing units included in the image synthesizer is not limited.

According to a first modification, the image synthesizer includes only one image compressing unit. A single image synthesizer operates a single conference. If the image synthesizer is clustered with another, a plurality of the clustered image synthesizers can operate a single conference. The image synthesizer generates synthesized image data with a screen arrangement, a compression coding method, a resolution, a frame rate, and a bit rate that are common to all the conference terminals connected to the image synthesizer, and sends the synthesized image data to all of the conference terminals connected thereto.

The image synthesizer can be configured to use a scalable coding as a compressing coding method. With the scalable coding, even if the image synthesizer includes only one image compressing unit, the image synthesizer can extract a plurality of image data with different resolutions or bit rates from the compressed image data, whereby sending image data processed as appropriate to each conference terminal.

In the embodiment described above, if the image synthesizers 110a and 110b are clustered with each other, by receiving the registration information from the image synthesizer 110a, the entry of the image synthesizer 110a is registered to the resource storage unit 303 in the conference controller 100. At this time, the fact that the image synthesizers are clustered is not yet registered. Upon receiving the registration information from the image synthesizer 110b, the registering unit 311 registers the fact of the clustering to the entries of the image synthesizers 110a and 110b in the resource storage unit 303. However, the embodiment is not limited to the registration method as described above.

For example, if the image synthesizers 110a and 110b are clustered with each other, the conference controller 100 can be configured to register the fact of the clustering to the resource storage unit 303 at the time of receiving the identifiers of the clustered image synthesizers from one of the image synthesizers 110a and 110b.

The present invention is not limited to the embodiment, and it can be realized with the units modified within the scope of the invention.

For example, according to the embodiment, the conference controller 100 and the image synthesizers 110a, 110b, and 110c are independent devices. However, the conference controller 100 can include the function of the image synthesizers. If the multipoint teleconference system is realized by a plurality of the conference controllers that include the image synthesizers, any one of the conference controllers intensively performs the registration process for other image synthesizers.

A plurality of the units disclosed in the embodiment and the modification can be combined as needed. For example, some of the units can be removed. Moreover, the units separately disclosed in the embodiment and the modification can be combined as needed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A communication controller that controls communications of devices via a multiplex communication network, the devices including at least two information synthesizers bilaterally connected with an exclusive line and at least two terminal devices that send information to be synthesized by the information synthesizers, the communication controller comprising:
a receiving unit that receives first ID and second ID from the information synthesizers, the first ID being ID of an information synthesizer bilaterally connected to one of the information synthesizers and second ID being ID of the one of the information synthesizers;
a storage unit that stores the first ID received and the second ID received associated with each other; and
an assigning unit that assigns a one of the terminal devices to the first information synthesizer and the other of the terminal devices to the second information synthesizer, when both of the first ID and the second ID received from the first information synthesizer match both of the first ID and the second ID received from the second information synthesizer.

2. The communication controller according to claim 1, further comprising a sending unit that sends the ID of the one terminal device to the first information synthesizer and the ID of the other terminal device to the second information synthesizer via the multiplex communication network.

3. The communication controller according to claim 1, wherein
the storage unit includes a maximum number of pieces of the information that can be synthesized at a time with respect to each information synthesizer, and
the assigning unit assigns a number of terminal devices to the first information synthesizer, the number being less than the maximum number of pieces of the information that the first information synthesizer can synthesize.

4. The communication controller according to claim 1, wherein the assigning unit assigns the one terminal device to the first information synthesizer and the other terminal device to the second information synthesizer when the receiving unit receives a request from the terminal device.

5. The communication controller according to claim 1 further comprising a clock to measure a current time, wherein
the storage unit further stores a scheduled time to assign the one terminal device to the first information synthesizer and the other terminal device to the second information synthesizer, and
the assigning unit assigns the one terminal device to the first information synthesizer and the other terminal device to the second information synthesizer when the current time reaches the scheduled time.

6. An information synthesizer comprising:
a first communicating unit that receives ID of other information synthesizer, sends ID of the information synthesizer to the other information synthesizer, and receives first information to be synthesized via an exclusive line that bilaterally connects the information synthesizer to the other information synthesizer;
a second communicating unit that sends the ID of the other information synthesizer to a communication controller along with the ID of the information synthesizer, receives the ID of a first terminal device from the communication controller, and receives second information to be synthesized from the first terminal device via a multiplex communication network for multiplex communication with the first terminal device, the communication controller, and the other information synthesizer; and
a synthesizing unit that synthesizes the first information and the second information to generate synthesized information.

7. The information synthesizer according to claim 6, wherein the exclusive line is capable of communication faster than communication via the multiplex communication network.

8. The information synthesizer according to claim 6, wherein
the first communicating unit further receives third information,
the second communicating unit further receives layout information for the first terminal device, ID of a second terminal device, and layout information for the second terminal device from the communication controller, and receives fourth information from the second terminal device via the multiplex communication network for the multiple communication further with the second terminal device, and
the synthesizing unit synthesizes the third information and the fourth information based on the layout information for the first terminal device to generate first synthesized information to be sent to the first terminal device, and synthesizes the first information and the second information based on the layout information for the second terminal device to generate second synthesized information to be sent to the second terminal device.

9. A computer program product having a computer readable medium including programmed instructions for controlling communications of devices via a multiplex communication network, the devices including at least two information synthesizers bilaterally connected with an exclusive line and at least two terminal devices that send information to be synthesized by the information synthesizers, wherein the instructions, when executed by a computer, cause the computer to perform:
receiving first ID and second ID from the information synthesizers, the first ID being ID of an information synthesizer bilaterally connected to one of the information synthesizers and second ID being ID of the one of the information synthesizers;
storing the first ID received and the second ID received associated with each other; and
assigning one of the terminal devices to the first information synthesizer and the other of the terminal devices to the second information synthesizer, when both of the first ID and the second ID received from the first information synthesizer match both of the first ID and the second ID received from the second information synthesizer.

10. The computer program product according to claim 9, wherein the instructions further cause the computer to perform sending the ID of the one terminal device to the first information synthesizer and the ID of the other terminal device to the second information synthesizer via the multiplex communication network.

11. The computer program product according to claim 10, wherein
the storing includes a maximum number of pieces of the information that can be synthesized at a time with respect to each information synthesizer, and
the assigning assigns a number of terminal devices to the first information synthesizer, the number being less than the maximum number of pieces of the information that the first information synthesizer can synthesize.

12. The computer program product according to claim 9, wherein the assigning assigns the one terminal device to the first information synthesizer and the other terminal device to the second information synthesizer when the receiving unit receives a request from the terminal device.

13. The computer program product according to claim 9, wherein the instructions further cause the computer to perform measuring a current time, wherein
the storing stores a scheduled time to assign the one terminal device to the first information synthesizer and the other terminal device to the second information synthesizer, and
the assigning assigns the one terminal device to the first information synthesizer and the other terminal device to the second information synthesizer when the current time reaches the scheduled time.

14. A computer program product having a computer readable medium including programmed instructions for synthesizing information to be synthesized and generating synthesized information, wherein the instructions, when executed by a computer, cause the computer to perform:
receiving ID of an information synthesizer via an exclusive line;
sending ID of the computer to the information synthesizer via the exclusive line;
sending the ID of the information synthesizer to a communication controller via a multiplex communication network along with the ID of the computer;
receiving ID of a terminal device from the communication controller via the multiplex communication network;
receiving first information from the information synthesizer via the exclusive line;
receiving second information to be synthesized from the terminal device via the multiplex communication network;
sending the second information to the information synthesizer via the exclusive line; and
synthesizing the first information and the second information to generate synthesized information.

15. The computer program product according to claim 14, wherein the exclusive line is capable of communication faster than communication via the multiplex communication network.

16. The computer program product according to claim 14, wherein the instructions further cause the computer to perform:
receiving third information to be synthesized;
receiving layout information for a first terminal device, ID of a second terminal device, and layout information for the second terminal device from the communication controller via the multiplex communication network; and
receiving fourth information to be synthesized from the second terminal device via the multiplex communication network, wherein
the third information and the fourth information are synthesized based on the layout information for the first terminal device to generate first synthesized information to be sent to the first terminal device, and
the first information and the second information are synthesized based on the layout information for the second terminal device to generate second synthesized information to be sent to the second terminal device.
